(19) United States
(12) Patent Application Publication
(10) Pub. No.: US 2009/0010760 A1
(43) Pub. Date: Jan. 8, 2009

(54) METHOD OF CORRECTING BALANCE OF GAS TURBINE

(76) Inventors: Yasushi Hayasaka, Mito (JP); Kazuyuki Yamaguchi, Tsuchiura (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/814,320

(22) PCT Filed: Jan. 21, 2005
(86) PCT No.: PCT/JP2005/000738

§ 371 Date: Jul. 19, 2007

(51) Int. Cl. F01D 25/04; F16F 15/00; F04D 29/66

(52) U.S. Cl. 416/144

(57) ABSTRACT

A method of correcting the balance of a gas turbine formed so that a balance between the generator side shaft end of a rotor and the shaft end of the gas turbine can be corrected within the range of service rotational speed. In the method, after the rotor is assembled in a casing, the balance is corrected while the rotor is rotated up to a high service rotational speed to remove its residual unbalance at the high rotational speed at which an unbalance due to the elastic deformation of the rotor occurs so as to reduce a vibration due to the unbalance. Accordingly, when the gas turbine is assembled, the residual unbalance resulting from the assembly of the gas turbine, a compressor, and a generator formed on a same rotating axis can be reduced. As a result, the gas turbine which does not increase a vibration at a critical speed can be provided.

### TECHNICAL FIELD

The present invention relates to a method of correcting a balance of a gas turbine.

### BACKGROUND ART

A gas turbine rotor is generally structured such that a generator, a compressor and a gas turbine are arranged on the same rotating axis. At this time, a bearing is arranged in both shaft ends of the generator, and the gas turbine and the compressor are adjacent to each other, thereby forming an overhang rotor in most cases. In the rotor mentioned above, an assembly tolerance at a time of assembling the gas turbine, the compressor and the generator comes to a residual unbalance amount.

If the residual unbalance is excessive, a vibration of the rotor becomes large at a time when the rotor passes through a critical speed, whereby there is a risk that the rotor and the casing come into contact with each other, and the bearing is damaged. In order to solve the problem mentioned above, for example, the patent document 1 (WO01/86130 A1) shows a low speed residual unbalance removing method of a rotor with which a generator, a compressor and a gas turbine are combined.

Patent Document 1: WO01/86130 A1

### DISCLOSURE OF THE INVENTION

### Problem to be Solved by the Invention

In the conventional gas turbine, the residual unbalance of the rotor obtained by combining the generator, the compressor and the gas turbine is removed at a rotational speed equal to or less than one tenth of a service rotational speed by using a balance test. In other words, it is possible to reduce the residual unbalance of a rigid rotor without taking a deformation of the rotor into consideration, however, it is impossible to remove the residual unbalance while taking the deformation of the rotor into consideration, at a high rotational speed corresponding to the service rotational speed. Accordingly, there is a risk that an unbalance vibration becomes large due to an elastic deformation of the rotor at the high rotating speed.

An object of the present invention is to achieve a balance correcting method of a gas turbine without increasing an unbalance vibration of removing a residual unbalance at a high rotational speed at which an unbalance is generated due to an elastic deformation of a rotor, by correcting a balance of a generator side shaft end of the rotor and a shaft end of the gas turbine in a service rotational speed range.

### Means for Solving the Problem

In accordance with the present invention, there is provided a method of correcting a balance of a gas turbine power generating apparatus constituted by a gas turbine rotor constructed by a gas turbine, a compressor and a generator arranged coaxially with the gas turbine and the compressor, a combustor mixing a discharge air from the compressor and a fuel so as to burn, and a non-rotating member constructed by a transition piece and a gas turbine nozzle which supply a generated combustion gas to the gas turbine, and a casing internally capsuling the gas turbine, the compressor and the generator, wherein the method corrects the balance of a generator side shaft end of the gas turbine rotor and a shaft end of the gas turbine, within a range of a service rotational speed.

### EFFECT OF THE INVENTION

In accordance with the present invention, since it is possible to correct the balance in the generator side shaft end of the gas turbine rotor and the gas turbine side shaft end, it is possible to correct the balance while rotating the gas turbine rotor to a high rotational speed corresponding to the service rotational speed, after assembling the gas turbine rotor in the casing, it is possible to remove a residual unbalance at the high rotational speed at which the unbalance is generated by an elastic deformation of the gas turbine rotor, and it is possible to reduce an unbalance vibration.

### BRIEF DESCRIPTION OF THE DRAWINGS

FIG. 1 is a cross sectional view of a gas turbine showing a first embodiment in accordance with the present invention;

FIG. 2 is a cross sectional view of the gas turbine showing the first embodiment in accordance with the present invention;

FIG. 3 is a cross sectional view of the gas turbine showing the first embodiment in accordance with the present invention;

FIG. 4 is a cross sectional view of the gas turbine showing the first embodiment in accordance with the present invention;

FIG. 5 is a cross sectional view of the gas turbine showing the first embodiment in accordance with the present invention;

FIG. 6 is a cross sectional view of the gas turbine showing the first embodiment in accordance with the present invention; and

FIG. 7 is a cross sectional view of the gas turbine showing the first embodiment in accordance with the present invention.

### DESCRIPTION OF REFERENCE NUMERALS

10 . . . gas turbine rotor, 12 . . . gas turbine outside casing, 14 . . . gas turbine, 16 . . . rotor shaft, 18 . . . compressor, 20 . . . generator, 22 . . . disc, 22a . . . thread hole, 22b . . . correcting screw, 24 . . . tie bolt, 26 . . . through hole, 28 . . . gas turbine blade portion, 30 . . . balance correcting portion, 32 . . . combustor, 34 . . . compressor blade portion, 36 . . . generator core, 38 . . . permanent magnet, 40 . . . cover, 42 . . . generator rear ring, 44 . . . gas turbine outside casing, 46 . . . transition piece, 48 . . . nozzle, 49 . . . regenerated heat exchanger, 50 . . . compressor casing, 50a . . . compressor casing lower half portion, 50b . . . compressor casing upper half portion, 52 . . . generator rear casing, 53 . . . generator coil, 54 . . . cooling jacket, 56 . . . generator casing, 58 . . . generator front casing, 59 . . . bolt, 60 . . . strut, 62 . . . spacer, 64 . . . gas turbine nozzle fixing structure body, 66 . . . labyrinth seal, 68 . . . compressor diffuser, 70 . . . bolt, 72 . . . fastening nut, 74 . . . bolt, 76 . . . radial bearing, 78 . . . thrust bearing, 80 . . . front side radial bearing, 82 . . . gas turbine support, 84 . . . bearing collar, 86 . . . bearing collar, 88 . . . shaft end, 90 . . . grinder, 94 . . . grinder sharpening stone, 96 . . . nut, 98 . . . gas turbine rotor end, 100 . . . seal ring, 102a, 102b . . . flange, 104 . . . bolt, 105 . . . access hole, 106 . . . mass, 108 . . . plug thread hole, 110 . . . plug thread, 112 . . . detachable flow path, 114 . . . bolt, 116 . . . flange, 118 . . . exhaust gas outlet portion, 122 . . . exhaust duct, 124 . . . access hole, 126 . . . bolt, 128 . . . mechanism for gripping gas turbine main body, 130 . . . apparatus for correcting balance, 132 . . . apparatus for driving balance correcting apparatus.

### BEST MODE FOR CARRYING OUT THE INVENTION

A description will be given below of a mode for carrying out the present invention with reference to the accompanying drawings.

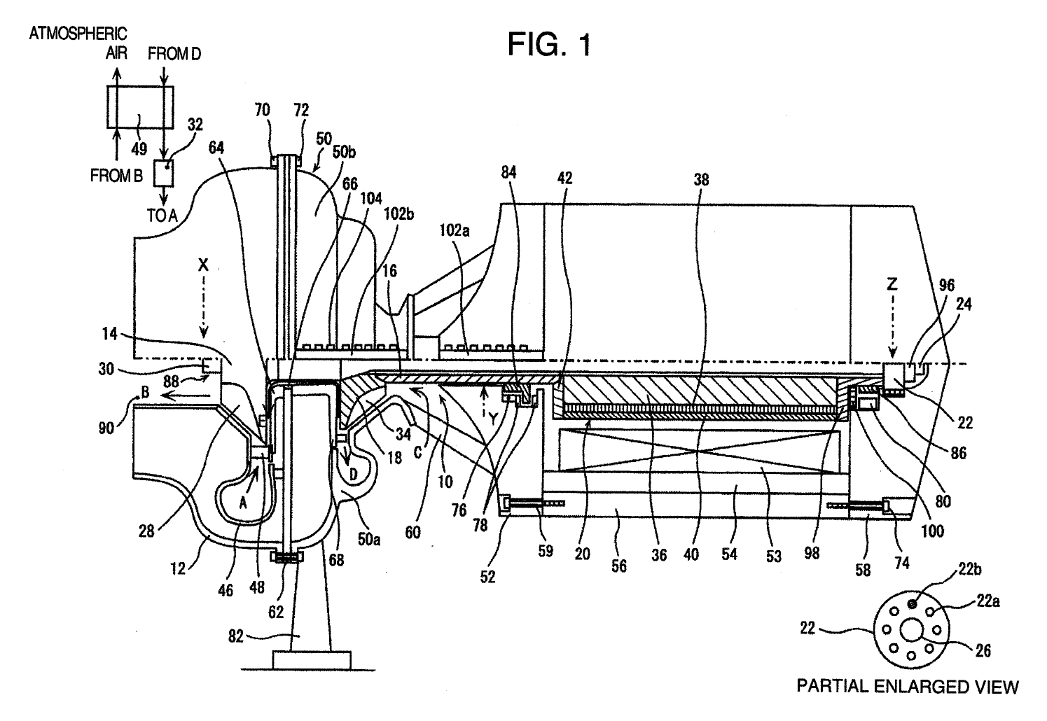

FIG. 1 is a cross sectional view of a gas turbine rotor 10 and a gas turbine outside casing 12 showing an embodiment in accordance with the present invention. The gas turbine rotor 10 is constituted by a gas turbine 14, a rotor shaft 16, a compressor 18, a generator arranged coaxially with the gas turbine 14 and the compressor 18, and a disc 22 attached to a shaft end of the generator 20.

As shown in a detailed drawing, the disc 22 is provided, for example, with a lot of thread holes 22a on a circumference. A balance correction is executed by screwing a correcting screw 22b in the thread hole 22a as occasion demands. A tie bolt 24 is bonded to a center of rotation of the gas turbine 14, the tie bolt 24 is inserted to the compressor 18, the rotor shaft 16, the generator 20 and a through hole 26 provided in a center of rotation of the disc 22, whereby the compressor 18, the rotor shaft 16, the generator 20 and the disc 22 are piled up, and are constructed by fastening an end portion of the tie bolt 24 by a nut.

The gas turbine 14 is constituted by a radial flow gas turbine, and is provided with a blade portion 28, and a balance correcting portion 30 arranged in a gas turbine end. A combustion gas introduced from the combustor 32 is expanded by the gas turbine blade portion 28 so as to rotate the gas turbine 14. The compressor 18 is constituted by a centrifugal compressor, and compresses an air by a blade portion 34. The generator 20 is lapped over the rotor shaft 16. The generator 20 is constituted by a generator core 36, a permanent magnet 38, a cover 40 and a generator rear end ring 42. The generator core 36 is constituted by a cylinder structured by a magnetic material, and passes the tie bolt 24 through a center hole thereof.

The permanent magnet 38 is also formed in a cylindrical shape or a divided cylindrical shape, and is fitted to an outer periphery of the generator core 36. Next, the cover 40 is fitted to an outer side of the permanent magnet 38 so as to prevent the permanent magnet 38 from flying in all directions due to the rotation or slipping with respect to the generator core 36. The permanent magnet 38 is pressed to the generator core 36 on the basis of a compression stress in a diametrical direction by forming the cover 40 as a close fitting engagement structure. The power is generated on the basis of the rotation of the generator 20 within a stationary body of the generator.

The gas turbine 14 is rotated within a gas turbine casing constructed by the gas turbine outside casing 12 and a transition piece 46. A combustion gas flowing out from the combustor 32 flows as shown by an arrow A, is rectified by a nozzle 48, is expanded while passing through the gas turbine blade 28 of the gas turbine 14, and flows out in a direction of an arrow B. The combustion gas flowing out in accordance with an arrow B is introduced to a regenerated heat exchanger 49.

The compressor 18 sucks an air as shown by an arrow C, compresses the air by the compressor blade portion 34 of the compressor 18, and discharges the air in a direction of an arrow D. The compressed air discharged in accordance with an arrow D is introduced to the regenerated heat exchanger 49, is preheated, and is introduced to the combustor 32. The generator 20 is rotated within a non-rotating member of the generator 20 constituted by a compressor casing 50, a generator rear casing 52, a generator coil 53, a cooling jacket 54, a generator casing 56, and a generator front casing 58 so as to generate power. The generator rear casing 52 is detachable by a bolt 59. The compressor casing 50 and the generator casing 56 are connected by a strut 60. The strut 60 corresponds to a beam bridged between compressor casings 50a and 50b, and the generator casing 52, and has a function of integrating these elements. An alternating current induced in the generator coil 53 is converted into a direct-current electricity by a rectifier (not shown), and is converted into an alternating current by an inverter.

In order to reduce an unbalance vibration of the gas turbine rotor 10 at a critical speed at a time of operating the gas turbine 14, it is necessary to reduce a residual unbalance of the gas turbine rotor 10 in a state in which the gas turbine rotor 10 is assembled. The reduction of the residual unbalance is executed by using a balancer. The residual unbalance of the gas turbine rotor 10 is reduced by cutting a member, or removing a mass or adding a mass. It is possible to correct an unbalance of the gas turbine rotor 10 serving as a rigid rotor on the basis of the balance correction using the balancer.

Next, a description will be given of the non-rotating member of the gas turbine 14. The gas turbine rotor 10 mentioned above is rotated within a stationary body constituted by the gas turbine outside casing 12, the transition piece 46, the gas turbine nozzle 48, a spacer 62, a gas turbine nozzle fixing structure body 64, a labyrinth seal 66, a compressor diffuser 68, a fastening bolt 70 connecting the divided gas turbine outside casing 12, a fastening nut 72, the compressor casing 50, the generator front casing 58, the generator coil 53, the cooling jacket 54, the generator front casing 58, a bolt 74, a radial bearing 76, a thrust bearing 78, a front side radial bearing 80, and a gas turbine support 82. The turbine support 82 supports the gas turbine outside casing 12.

The gas turbine rotor 10 balances in a high rotational speed until a service rotational speed, by using a balance correcting surface X in a leading end of the gas turbine rotor 10, a balance correcting surface Z in a shaft end of the generator 20, and a balance correcting surface Y between the compressor 18 and the generator 20. As a procedure of the balancing, an electric current is supplied to the generator 20, the generator 20 is operated as a motor, and the gas turbine rotor 10 is rotated. Further, an amplitude by vibration of the gas turbine rotor 10 is measured near bearing collars 84 and 86. The measurement of the vibration is executed by using a displacement meter fixed to the non-rotating member. The gas turbine rotor 10 is rotated from a low speed, the amplitude by vibration is measured, and the rotational speed is increased up to the service rotational speed while measuring a vibration response of the turbine rotor 10.

The vibration response is reduced by adding the mass to the positions of the balance correcting surfaces X, Y and Z or removing the mass from the positions of the balance correcting surfaces X, Y and Z on the basis of the measured vibration response. As a method of correcting the unbalance, there is an influence coefficient method or the like. At a time of correcting the balance, in the case that the amplitude by vibration gets over a previously determined threshold value, an alarm is generated or an emergency stop of the gas turbine 10 is executed, off course, by using a measured signal of the amplitude by vibration of the gas turbine rotor 10.

At a time of correcting the balance, the balance correction of the correcting surface X is executed by accessing from an inverse direction to the gas flow path direction B at a time when the gas turbine rotor 10 stops. The gas turbine in accordance with the embodiment of the present invention is structured such that a circumference of the gas turbine 14 is surrounded by the gas turbine outside casing 12 and the transition piece 46. Accordingly, it is hard to correct the residual unbalance existing in the gas turbine 14 portion of the gas turbine rotor 10.

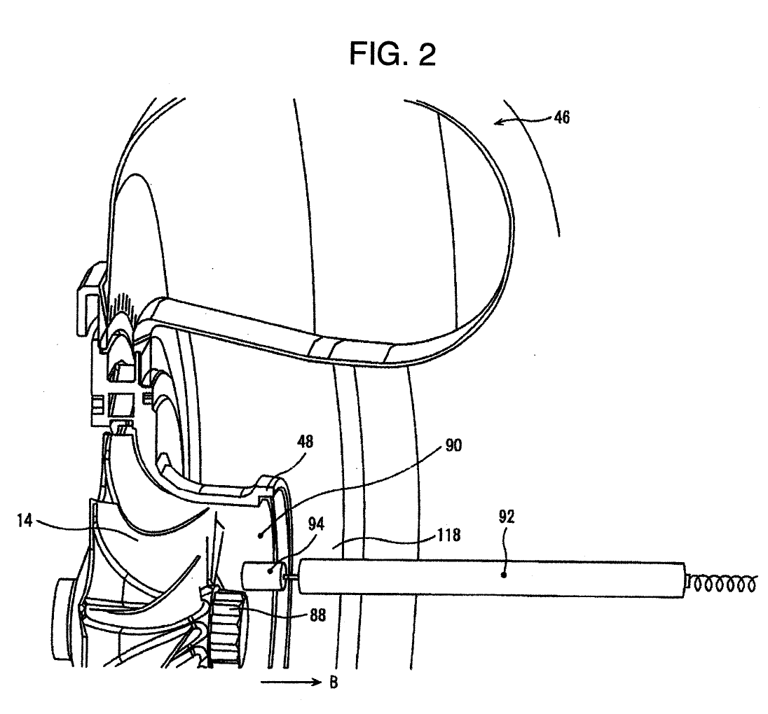

In the gas turbine power generating apparatus in accordance with the embodiment of the present invention, since the balance correcting surface X is provided in a gas turbine shaft end 88, the residual unbalance can be corrected by the balance correcting surface X provided in the gas turbine shaft end 88 by accessing from a space of a flow path 90 of the exhaust gas of the gas turbine in the opposite direction to the gas turbine gas flow path direction B, as shown in FIG. 2. The residual unbalance is corrected by removing a mass of the gas turbine shaft end 88 by a machine tool such as a grinder 92, 94 or the like, or an electric discharge machine, or adding the mass, for example, by embedding a screw or the like therein.

In the embodiment in accordance with the present invention, the balance correcting surface Z is provided also in the shaft end of the generator. The generator 20 is surrounded by the generator casing 56, and the generator front casing 58 so as to be rotated. Accordingly, it is generally hard to correct the residual unbalance of the generator 20. However, in the embodiment in accordance with the present invention, the structure is made such that the balance correcting surface Z is provided also in the shaft end of the generator 20. In the case that the balance correction is necessary, it is possible to access to the balance correcting surface Z by detaching the bolt 74, and detaching the front casing 58 of the generator 20.

Accordingly, it is possible to easily reduce the residual unbalance of the gas turbine rotor 10 so as to reduce the unbalance vibration. In FIG. 1, the disc 22 is attached to the shaft end of the generator 20 by the tie bolt 24. In the shaft end of the generator 20, the disc 22, the leading end of the tie bolt 24, a nut 96, the bearing collar 86, and a gas turbine rotor end 98 can be considered as the balance correcting surface. Since the disc 22 can secure a large radius for correcting the residual unbalance in comparison with the leading end of the tie bolt 24, the nut 98, the bearing collar 86 and the gas turbine rotor end 98, and has a small effect on the gas turbine rotor 10 in the light of the performance and the reliability, the disc 22 is preferable for being used as the balance correcting surface Z. The method of correcting the balance is the same as the method in the gas turbine side balance correcting surface X. A seal ring 100 is attached to the rotor end 98 in accordance with an engagement.

Further, the structure is made such that the disc 22 can regulate partial charge of the loads of the bearings 76 and 80 by regulating a dimension of the disc 22. In other words, in the case that the load of the bearing 80 in the shaft end of the generator is too small due to the overhang, and the vibration supposed to be caused by the small bearing load is generated, the load of the bearing 80 is increased by enlarging the weight of the disc 22.

In the embodiment in FIG. 1, the balance correcting surface Y is provided between the compressor and the generator. Accordingly, it is easy to correct the residual unbalance of the vibration mode in which the center of the whole of the gas turbine rotor 1 form a body. Because the balance correcting surface Y between the compressor and the generator is positioned approximately at the center portion of the gas turbine rotor 10. The access to the balance correcting surface Y is executed by disassembling the compressor casing 50 which is divided into the compressor casing lower half portion 50a and the compressor casing upper half portion 50b, in the case in FIG. 1. First, a bolt 104 in flanges 102a and 102b is detached, and the compressor casing upper half portion 50b is detached.

In the balance correcting surface Y, it is possible to correct the residual unbalance in accordance with the same method as the correcting surface X mentioned above, by using the rotor shaft 16, the bearing collar 84 and the generator rear end ring 42. In this case, with regard to the balance surface Y, it is possible to prevent a phenomenon that the mass added by the balance correction is sucked into the compressor, by not putting the balance correcting position in a surface which is exposed to a flow path of the sucked air of the compressor shown by an arrow C.

Further, in the correcting surface Y, it is desirable to employ a method of screwing the mass into a thread hole provided in a vertical direction to an axial direction of the gas turbine rotor 10 in comparison with the method of removing the mass by cutting or the like, because it is possible to prevent a stress concentration from being generated.

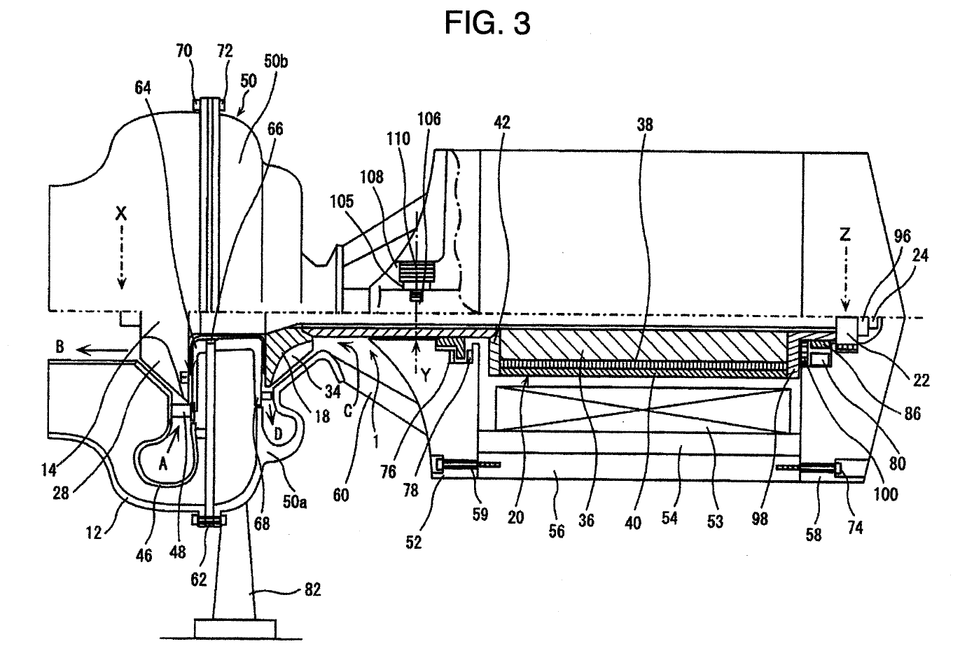

Further, as the method of accessing to the balance correcting surface Y, in the case that no horizontal divided surface is provided in the compressor casing 50, there can be considered a method of setting an access hole 105 in the compressor casing in accordance with a method shown in FIG. 3, leaving open the access hole 105, and screwing a mass 104 into a thread hole provided in the vertical direction to the axial direction of the gas turbine rotor 10. A closure of the access hole 105 at a time of operating the gas turbine is executed by forming a plug thread hole 108 in the compressor casing 50, and fastening a plug screw 110.

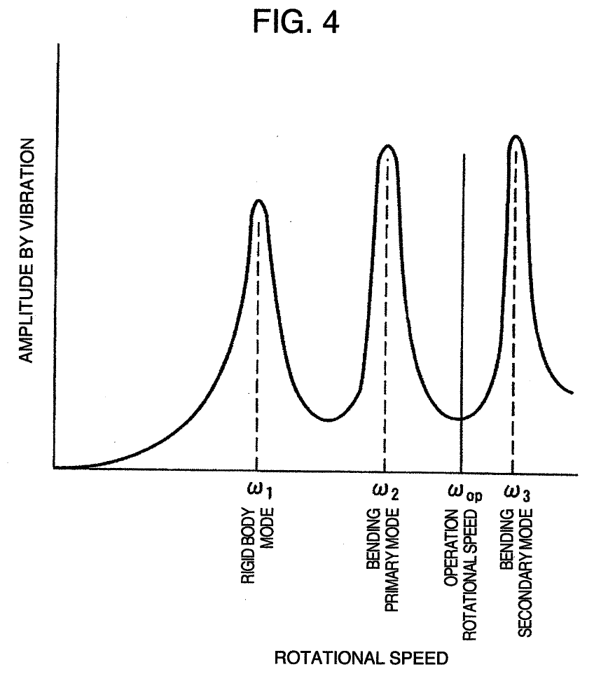

FIG. 4 shows a schematic view of an effect of the embodiment in accordance with the invention shown in FIG. 1. In the unbalance vibration of the gas turbine rotor 10 having the overhang, there is obtained a relation between the amplitude by vibration and the rotational speed, shown in FIG. 4. As a peak at which the amplitude is enlarged, there exist a peak caused by the bearing rigidity and a peak caused by a bending primary mode vibration of the shaft. In a rated rotational speed, there is a possibility that the peak rests on a skirt of a secondary bending mode in some cases.

In other words, it is necessary to reduce three peaks. In the structure shown in FIG. 1, since the balance correcting surfaces are provided at three positions, and it is possible to rotate at the service rotational speed, it is possible to reduce the amplitude by vibration with respect to all the peaks shown in FIG. 4. Since three correcting surfaces are provided, it is possible to easily reduce three peaks. Accordingly, it is possible to provide the gas turbine having a high reliability. In this case, in each of the balance correcting surfaces X, Y and Z, a plurality of correcting surfaces can be provided in each of them, in accordance with a variation of the embodiment.

There is shown above the method of operating the generator 20 as the motor, increasing the rotation of the gas turbine rotor 10 up to the high rotational speed such as the rated rotational speed, and reducing the residual unbalance. In accordance with this method, the gas turbine blade portion 28 and the compressor blade portion 34 agitate the air so as to form the resistance. Accordingly, in the motor driving of the generator 20, there is a risk that it is impossible to increase the rotational speed of the gas turbine up to the rated rotational speed.

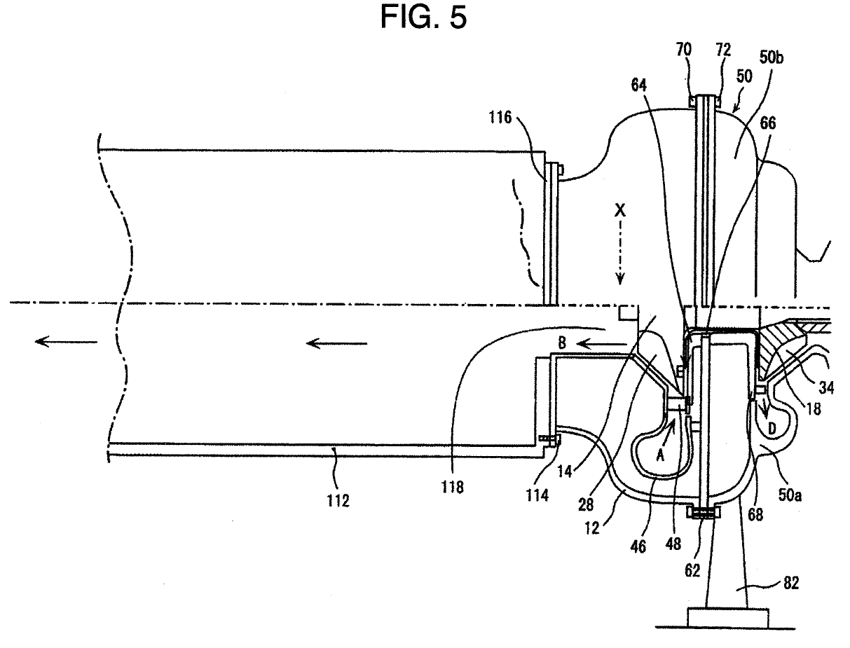

In the case mentioned above, the rotational speed of the gas turbine 14 is increased up to the rated rotational speed by using the shaft rotational torque of the gas turbine 14. In this case, at this time, as shown in FIG. 5, the balance correction of the gas turbine rotor 10 becomes easy by setting a detachable flow path 112 in the exhaust portion of the gas turbine 14. The flow path 112 can be attached and detached by detaching a bolt 114.

In other words, in a state in which the fuel is put in the combustor 32 of the gas turbine rotor 10, a high-temperature gas turbine exhaust gas is discharged to a safe position by attaching the detachable flow path 112. In the case that the balance correction is necessary in the gas turbine side balance correcting surface X, the residual unbalance is corrected by detaching the bolt 114 and the flange 114 of the detachable flow path 112, detaching the flow path 112, and accessing to the correcting surface X. The method of correcting the balance is the same as the method mentioned above in the description of FIG. 1.

At a time of correcting the balance, it is possible to execute the balance correction by setting a jig provided with a heat insulating material in an exhaust gas outlet portion 118 of the gas turbine, without exposing a worker and a machine tool executing the balance correction to a high temperature and without waiting for cooling of the gas turbine 14. The flow path 112 may employ a piping, a bellows or the like, and a gasket may be provided in the flange surface.

Since the pressure of the gas turbine exhaust gas is approximately close to the atmospheric air, it is sufficient to fasten by a reduced number of bolts or joints. It is possible to prevent the gas turbine exhaust gas from being discharged to the atmospheric air just after the gas turbine, by setting the flow path 112, whereby it is possible to safely correct the balance. In this case, the balance correcting method of the balance correcting surfaces X, Y and Z is the same as the method shown in the description of FIG. 1.

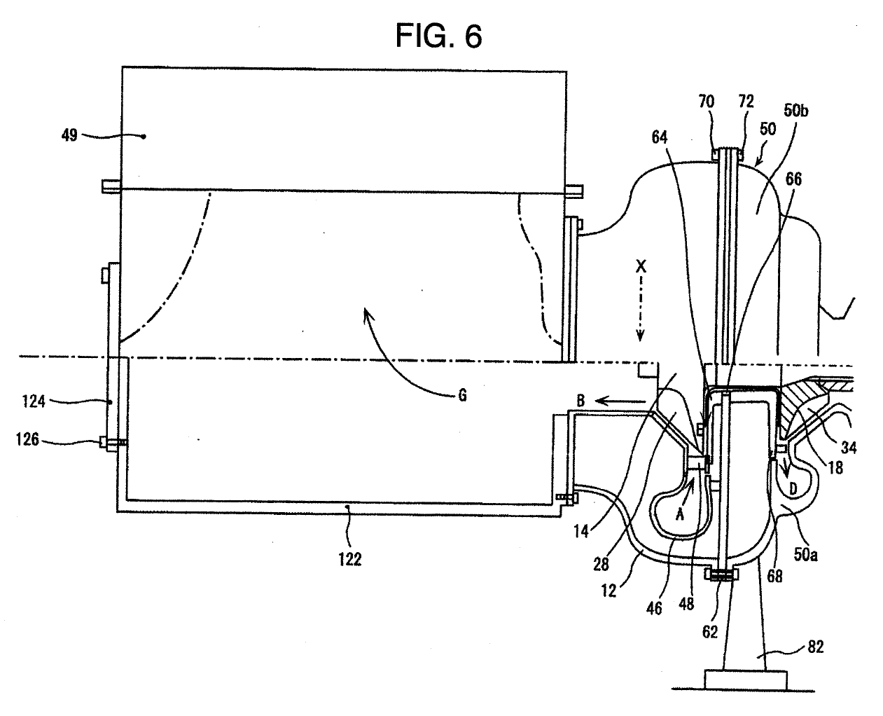

FIG. 6 shows a balance correcting method of the balance correcting surface X in a state of assembling an exhaust duct 122 introducing the gas turbine exhaust gas to the regenerated heat exchanger 49. This shows a method of easily correcting the balance at a time of operating. In the gas turbine 10 in accordance with the present invention, the exhaust gas of the gas turbine is introduced to the regenerated heat exchanger 49 as shown by an arrow G. At this time, a duct 122 is provided between the gas turbine exhaust portion and the regenerated heat exchanger 120. The balance correction of the balance correcting surface X is executed as shown in FIG. 2, by setting an access hole 124 in the duct 122, and inserting the machine tool from the access hole 124. The access hole 124 is attached and detached by a bolt 126. The access hole 124 desirably exists on a shaft center of the turbine rotor 10, in the light of a visibility and a workability.

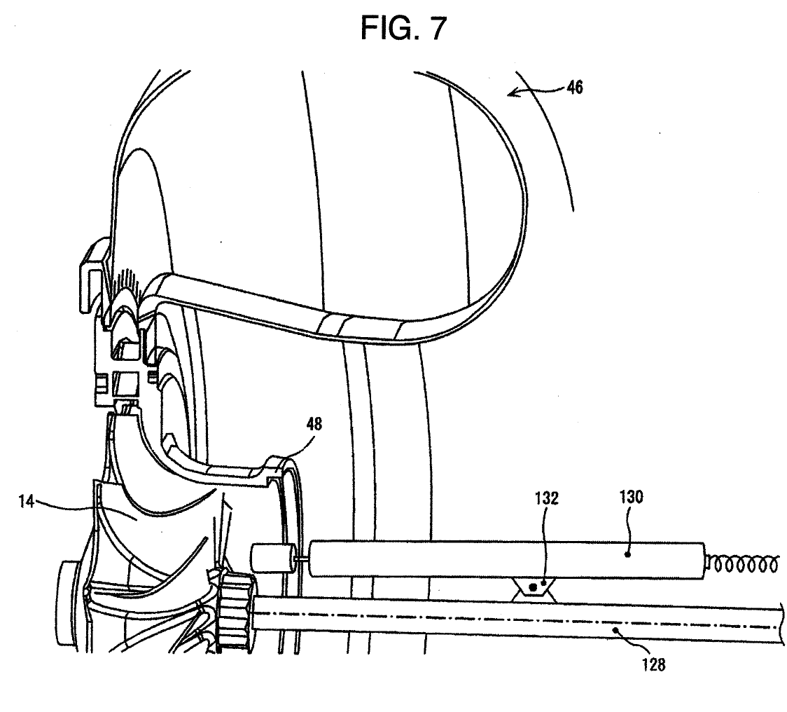

FIG. 7 shows a tool executing the balancing in the gas turbine side. As shown in the drawing, the balance correction may be executed by using a balance correcting apparatus having a mechanism 128 gripping the gas turbine main body, a balance correcting apparatus 130, and an apparatus 1132 driving the balance correcting apparatus. As the mechanism 128 gripping the gas turbine main body, there is provided a mechanism of inserting or screwing a rod-like structure to a hole provided in the shaft end of the gas turbine 14, a suction cup, a magnet, a clamp mechanism, or the like. Further, the balance correcting apparatus 130 includes a machine tool such as a grinder or the like, an electric discharge machining apparatus or the like. The apparatus 132 driving the balance correcting apparatus preferably employs a link mechanism, a pinion, a motor, a pneumatic cylinder or the like.

### INDUSTRIAL APPLICABILITY

The present invention can be utilized in a generator equipment.

1. A method of correcting a balance of a gas turbine power generating apparatus constituted by a gas turbine rotor constructed by a gas turbine, a compressor and a generator arranged coaxially with the gas turbine and the compressor, a combustor mixing a discharge air from the compressor and a fuel so as to burn, a non-rotating member constructed by a transition piece and a gas turbine nozzle which supply a combustion gas of the combustor to the gas turbine, and a casing internally capsuling the gas turbine, the compressor and the generator, and a support supporting the gas turbine rotor, wherein the method corrects the balance of a generator side shaft end of the gas turbine and the other end side shaft end of the gas turbine, within a range of an actual operation rotational speed.

2. A method of correcting a balance of a gas turbine power generating apparatus as claimed in claim 1, wherein the balance is corrected between the compressor and the generator.

3. A method of correcting a balance of a gas turbine power generating apparatus as claimed in claim 1, wherein a disc is attached to an outer end of a generator shaft, and the disc is used for correcting a residual unbalance.

4. A method of correcting a balance of a gas turbine power generating apparatus constituted by a gas turbine rotor constructed by a gas turbine, a compressor and a generator arranged coaxially with the gas turbine and the compressor, a combustor mixing a discharge air from the compressor and a fuel so as to burn, a non-rotating member constructed by a transition piece and a gas turbine nozzle which supply a combustion gas of the combustor to the gas turbine, and a casing internally capsuling the gas turbine, the compressor and the generator, and a support supporting the gas turbine rotor, wherein the method corrects the balance of a generator side shaft end of the gas turbine, the other end side shaft end of the gas turbine, between the compressor and the generator, and a disc attached to an outer shaft of the generator shaft, within a range of an actual operation rotational speed.

5. A method of correcting a balance of a gas turbine power generating apparatus as claimed in claim 1, wherein a detachable flow path is provided in an exhaust portion of the gas turbine, an exhaust gas is discharged through the flow path at a time when the gas turbine is rotated, the flow path is detached at a time when the balance is corrected, and the balance is corrected in a shaft end of the gas turbine.
